(19) United States
(12) Patent Application Publication
(10) Pub. No.: US 2014/0178023 A1
(43) Pub. Date: Jun. 26, 2014

(54) HYBRID PHOTONIC CRYSTAL FIBER, AND METHOD FOR MANUFACTURING SAME

(71) Applicants: Kyung-Hwan Oh, Gyeonggi-do (KR); Ji-Young Park, Seoul (KR)

(72) Inventors: Kyung-Hwan Oh, Gyeonggi-do (KR); Ji-Young Park, Seoul (KR)

(73) Assignee: INDUSTRY-ACADEMIC COOPERATION FOUNDATION, YONSEI UNIVERSITY, Seoul (KR)

(21) Appl. No.: 14/236,300

(22) PCT Filed: Jan. 11, 2012
(86) PCT No.: PCT/KR2012/000277

§ 371 Date: Jan. 30, 2014

(30) Foreign Application Priority Data
Jan. 13, 2011 (KR) 10-2011-0003458

(51) Int. Cl. G02B 6/02; C03B 37/15

(52) U.S. Cl. CPC G02B 6/02314; C03B 37/15
USPC 385/125; 65/407

(57) ABSTRACT

The present invention relates to a hybrid photonic crystal fiber, into the core of which a functional material is injected. The hybrid photonic crystal fiber of the present invention comprises: a central hole having a diameter of 4 to 15 μm extending in the longitudinal direction; an inner cladding also formed in the longitudinal direction outside the central hole, having a hexagonal arrangement of air holes, each of which has a diameter of 2 to 5 μm and a lattice constant of 4.5 to 7 μm; an annular outer cladding surrounding the outer surface of the inner cladding; and a core formed by filling a functional material in some of the air holes including the central hole. According to the present invention, changes in the state, i.e. the liquid, liquid-crystal, or biofluid states, of the functional material that fills the core that has a variety of shapes may enable the modulation of light intensity, wavelength, phase, and polarization, and thus enable various photonic networks to be produced. The hybrid photonic crystal fiber of the present invention may serve as various optical sensors capable of sensing changes in refractive index caused by external stresses such as temperature and pressure. The hybrid photonic crystal fiber of the present invention may be used as a light source for a fluorescent dye laser for a visible ray zone using fluorescent dye, or for an ultra-wideband laser of 700 nm or higher using high nonlinear liquid.

### TECHNICAL FIELD

The present invention relates to a hybrid photonic crystal fiber including a core formed by filling with a functional material. More specifically, the present invention relates to a hybrid photonic crystal fiber including a central core, whose shape may vary, formed by filling with a functional material such as a liquid, a liquid crystal or a biofluid wherein light intensity, wavelength, phase and polarization can be modulated in response to changes in the state of the functional material, thus being suitable for use in the construction of various optical communication networks and the application to fluorescent dye lasers and optical sensors, and a method for fabricating a hybrid photonic crystal fiber including a core, whose shape may vary, formed by filling with a functional material without changing the size of the core.

### BACKGROUND ART

With the recent developments of photonic crystal fibers (PCFs) in which air holes are regularly arranged in silica glass, new forms of hybrid photonic crystal fibers have been designed in which a functional liquid is filled in all or a part of the air holes of the photonic crystal fibers. Based on these hybrid photonic crystal fibers, various devices, including birefringence control devices, wavelength-tunable fluorescence filters, fluorescent dye lasers, ultra-broadband light sources, and bio-chemical sensors, have been developed.

A general PCF has air holes formed at intervals of only a few micrometers. With this arrangement, there is a need to develop a process for selectively filling a liquid in just one of the air holes located at the center of the PCF, while minutely adjusting the filling location. All the conventional selective filling techniques are based on the method that block all air holes in the cladding region of a PCF and remain a central hole only to ultimately fill the liquid inside it. One of them used an ultraviolet (UV) light curable polymer to block air holes in the cladding region of a PCF. As this method is based on the use of capillary force, the suction speed of a liquid increases with increasing diameter of a tube. For this reason, the procedure of the method is rather complicated: a central hole portion is first blocked with UV curable polymer, the UV curable polymer is again filled in the cladding air holes and is again cured, and thereafter, only the blocked portions of the cladding are cleaved appropriately before filling the central hole with liquid.

An alternative method is known that uses arc discharge of a fusion splicer to block air holes in the cladding region, leaving only a central air hole open. However, it is necessary to undergo a troublesome procedure for optimizing the intensity and time of arc discharge in different optical fibers. Further, when the central hole size is not significantly different from the size of air holes in the cladding region, there is a high possibility that the central hole and the air holes of the cladding may be blocked together, making it impossible to practically apply the method.

In a general optical fiber, there occurs birefringence, a phenomenon wherein light propagates at different speeds in polarization directions (fast axis and low axis) due to changes in ambient environments or circularity arising during optical fiber production. The speed difference between such polarization modes leads to dispersion of light, causing many problems such as bit errors in the construction of high-speed optical communication networks of 10 Gbps or higher.

A representative alternative to avoid unexpected problems caused by birefringence is an elliptical core optical fiber in which the difference in light speed between polarization modes, i.e. birefringence index, is artificially made large, such that light is allowed to propagate only in a constant polarization plane (polarization maintenance) or is applied after the cutoff wavelength of one axis of the polarization directions to leave only polarization of the other axis (single polarization).

Considerable research efforts have concentrated on the development of elliptical solid core optical fibers. However, to the best of our knowledge, no studies have been conducted on the fabrication of elliptical liquid core optical fibers, and no report has appeared on liquid core optical fibers with various core shapes and photonic crystal fibers that can be used as birefringence control devices through changes in the state of liquids in response to ambient factors such as temperature and pressure.

### DISCLOSURE

### Technical Problem

Therefore, it is a first object of the present invention to provide a hybrid photonic crystal fiber including a central core, whose shape may vary, formed by filling with a functional material such as a liquid, a liquid crystal or a biofluid wherein light intensity, wavelength, phase and polarization can be modulated in response to changes in the state of the functional material, thus being suitable for use in the construction of various optical communication networks and the application to fluorescent dye lasers and optical sensors.

It is a second object of the present invention to provide a method for fabricating the hybrid photonic crystal fiber.

### Technical Solution

In order to achieve the first object of the present invention, there is provided a hybrid photonic crystal fiber including: a central hole having a diameter of 4 to 15 μm extending in the longitudinal direction; an inner cladding also formed in the longitudinal direction outside the central hole, having a hexagonal arrangement of air holes, each of which has a diameter of 2 to 5 μm and a lattice constant of 4.5 to 7 μm; an annular outer cladding surrounding the outer surface of the inner cladding; and a core formed by filling a functional material in some of the air holes including the central hole.

According to one embodiment of the present invention, the photonic crystal fiber may have an outer diameter of 100 to 250 μm.

According to one embodiment of the present invention, the core may have a circular, elliptical, triangular, tetragonal, pentagonal or hexagonal shape in cross section.

According to one embodiment of the present invention, the functional material filled in the central hole and some of the air holes around the central hole may be at least one liquid selected from deionized water, fluorescent dyes, including Rhodamin 6G, Fluorescein and coumarin 343, and high nonlinear liquids, including carbon disulfide, toluene and nitrobenzene, at least one liquid crystal selected from nematic fluids, including liquid crystals E7 and E48, or at least one biofluid selected from blood, urine, lymph and saliva.

In order to achieve the second object of the present invention, there is provided a method for fabricating a hybrid photonic crystal fiber, the method including: cleaving a hollow optical fiber and a photonic crystal fiber each; splicing the cleaved sections of the hollow optical fiber and the photonic crystal fiber using a fusion splicer; filling a functional material in a central hole of the photonic crystal fiber through the hollow optical fiber as an delivery tube; and cleaving the photonic crystal fiber whose core is filled with the functional material.

According to one embodiment of the present invention, the central hole of the hollow optical fiber may have a circular, elliptical, triangular, tetragonal, pentagonal or hexagonal shape in cross section.

According to one embodiment of the present invention, the functional material may be at least one liquid selected from deionized water, fluorescent dyes, including Rhodamin 6G, Fluorescein and coumarin 343, and high nonlinear liquids, including carbon disulfide, toluene and nitrobenzene, at least one liquid crystal selected from nematic fluids, including liquid crystals E7 and E48, or at least one biofluid selected from blood, urine, lymph and saliva.

According to one embodiment of the present invention, the hollow optical fiber may have an outer diameter of 100 to 250 μm and a central hole diameter of 4 to 15 μm.

According to one embodiment of the present invention, the photonic crystal fiber may have an outer diameter of 100 to 250 μm and a central hole diameter of 4 to 15 μm, and may have cladding air holes, each of which has a diameter of 2 to 5 μm and a lattice constant of 4.5 to 7 μm.

According to one embodiment of the present invention, the hollow optical fiber and the photonic crystal fiber may be spliced together by aligning the cleaved sections of the hollow optical fiber and the photonic crystal fiber at a gap of 40 to 55 μm, followed by arc discharge heating at an intensity of 10 mA for 2 to 3 seconds.

According to one embodiment of the present invention, the arc discharge heating may be performed once or intermittently two or three times.

According to one embodiment of the present invention, the functional material is filled in the central hole of the photonic crystal fiber through the hollow optical fiber as an delivery tube by a fluid pump provided at the opposite side to the side where the hollow optical fiber spliced to the photonic crystal fiber.

### Advantageous Effects

The hybrid photonic crystal fiber of the present invention includes a central core, whose shape may vary, formed by filling with a functional material such as a liquid, a liquid crystal or a biofluid. In response to changes in the state of the functional material, light intensity, wavelength, phase and polarization can be modulated. Thus, the hybrid photonic crystal fiber of the present invention is suitable for use in the construction of various optical communication networks and can serve as an optical sensor capable of detecting changes in refractive index caused by external stresses such as temperature and pressure. The use of a fluorescent dye as the functional material enables the utilization of the hybrid photonic crystal fiber as a light source of a fluorescent dye laser in the visible region. The use of a high nonlinear liquid as the functional material enables the utilization of the hybrid photonic crystal fiber as a light source of an ultra-broadband laser at 700 nm or higher. The method of the present invention requires no additional process for air hole blocking or fusion splicing, making the fabrication procedure highly efficient while maintaining the size of liquid core.

### DESCRIPTION OF DRAWINGS

FIG. 1 is a cross-sectional view of a photonic crystal fiber according to one embodiment of the present invention.

FIG. 2 is a perspective view illustrating a structure in which a hollow optical fiber and a photonic crystal fiber are spliced together in accordance with one embodiment of the present invention.

FIG. 3 illustrates cross-sectional views of hollow optical fibers having various hollow shapes, including circular, elliptical, triangular and tetragonal shapes that can be used to fabricate a hybrid photonic crystal fiber of the present invention.

FIG. 4 illustrates cross-sectional views of liquid core photonic crystal fibers having various shapes, including circular, elliptical, triangular and tetragonal shapes, that can be obtained after liquid filling in accordance with a method of the present invention.

FIG. 5 shows cross sections of a hollow optical fiber and a photonic crystal fiber having a central hollow defect that is used to fabricate a liquid core photonic crystal fiber of the present invention.

FIG. 6 is an image showing a structure in which a hollow optical fiber and a photonic crystal fiber are spliced together in accordance with one embodiment of the present invention.

FIG. 7 schematically shows processes for filling a liquid in a hollow optical fiber and an optical fiber after fusion splicing in accordance with one embodiment of the present invention.

FIG. 8 is an image showing a cross section of a hybrid photonic crystal fiber filled with a liquid after fusion splicing of a hollow optical fiber and an optical fiber in accordance with one embodiment of the present invention.

FIG. 9 is a cross-sectional view illustrating the incidence of light through a liquid core photonic crystal fiber according to one embodiment of the present invention.

FIG. 10 shows a view and an image showing a liquid core photonic crystal fiber sealed with a semi-spherical lens made of a UV-curable polymer at one end of optical fiber.

FIG. 11 shows guiding characteristics in the longitudinal direction of a liquid core photonic crystal fiber sealed with a UV-curable polymer at one distal end of the optical fiber, which evaluated measured by numerical analysis in Experimental Example 1.

FIG. 12 shows guiding characteristics in the longitudinal direction of a liquid core photonic crystal fiber sealed with a single-mode optical fiber by adiabatic splicing, which are evaluated by numerical analysis in Experimental Example 1.

FIG. 13 shows changes in output power after a liquid core photonic crystal fiber are sealed with a UV-curable polymer at both ends thereof and 635 nm laser light is incident thereon.

### BEST MODE

The present invention will now be described in more detail.

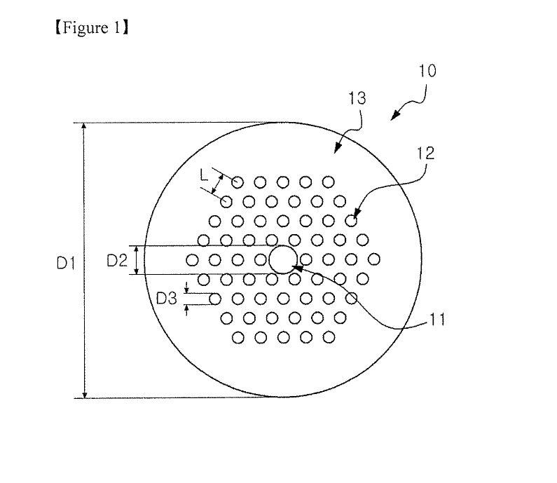

The present invention is directed to a new, highly efficient technique concerning a method for fabricating a hybrid photonic crystal fiber including a central core formed by filling with a functional material, compared to conventional techniques involving complex processes. The present invention is also directed to a hybrid photonic crystal fiber fabricated by the method. Referring to FIG. 1, the hybrid photonic crystal fiber is fabricated by filling a functional material in a central hole 11 of a photonic crystal fiber and some air holes 12 formed around the central hole. The hybrid photonic crystal fiber may include a core, whose shape may vary as illustrated in FIG. 4.

Specifically, the hybrid photonic crystal fiber of the present invention includes: a central hole having a diameter of 4 to 15 μm extending in the longitudinal direction; an inner cladding also formed in the longitudinal direction outside the central hole, having a hexagonal arrangement of air holes, each of which has a diameter of 2 to 5 μm and a lattice constant of 4.5 to 7 μm; an annular outer cladding surrounding the outer surface of the inner cladding; and a core formed by filling a functional material in some of the air holes including the central hole. The hybrid photonic crystal fiber has an overall outer diameter of 100 to 250 μm.

FIG. 1 illustrates a photonic crystal fiber according to one embodiment of the present invention. As illustrated in FIG. 1, the photonic crystal fiber includes a cladding layer 13 having an outer diameter D1 and air holes 12 having a diameter D3. The air holes 12 are formed inside the cladding layer and spaced at a lattice constant L. With this periodic arrangement of the air-silica crystal region, light could be confined and guided in an air core having a diameter D2. The hybrid photonic crystal fiber of the present invention is characterized in that the air hole or the innermost air holes including the air hole are filled with a functional material, preferably a liquid, a liquid crystal or a biofluid. As a result, the hybrid photonic crystal fiber of the present invention follows guide properties of the total internal reflection by having a refractive index distribution of standard step-index fibers.

The liquid crystal material is a special material that possesses both the fluidity of liquid and the anisotropic properties of crystal. When electric dipoles are aligned between particles by an external electric field, macroscopic birefringence effect takes place. When such a liquid crystal is filled in a general circular central hole and an external electric field is applied thereto, a birefringence control device can be realized, which is the same as the application of an elliptical liquid core photonic crystal fiber.

Biofluids, including blood, urine, lymph and saliva, are important measures of the health of patients. For example, blood containing cholesterol and glucose is used to diagnose cardiovascular diseases and diabetes mellitus. Such a biofluid filled in the central hole of the photonic crystal fiber serves as a light waveguide, and as a result, the photonic crystal fiber can be used as a biosensor through Raman scattering of the biofluid in the near-infrared region.

When a fluorescent dye is filled in the photonic crystal fiber, the fluorescent molecules absorb light and return back to the ground state to emit light in the visible region. Based on this light emission, the photonic crystal fiber can be used as a fluorescent dye laser. When a high nonlinear liquid is filled in the photonic crystal fiber, nonlinear guiding of an input laser light source takes place, and as a result, the photonic crystal fiber can be used as an ultra-broadband laser light source of 700 nm or higher.

The core of the hybrid photonic crystal fiber according to the present invention may have various shapes. Preferably, the core has a circular, elliptical, triangular, tetragonal, pentagonal or hexagonal shape in cross section.

FIG. 4 illustrates possible cross sections of the hybrid photonic crystal fiber in which a functional material is filled in the central hole and air holes around the central hole.

A general PCF has air holes formed at a lattice constant of only a few micrometers. With this arrangement, there is a need to develop a process for selectively filling a suitable material, such as a liquid, in just one of the air holes located at the center of the PCF in order to fabricate a liquid core photonic crystal fiber filled with the material. According to a conventional selective filling method, air holes in the cladding region of a photonic crystal fiber are blocked and only air holes around a core of the PCF are left open. Because this method is based on the difference in the suction speed of the liquid, which is induced by the difference in the diameter of the air holes, the portions of the cladding blocked by a UV curable polymer should be cleaved several times, making the fabrication procedure complicated. A problem of another conventional method is poor processing efficiency because arc discharge for blocking cladding air holes only should be performed under different intensity and time conditions on individual optical fibers. Further, an insignificant difference in size between the core and air holes in the cladding region makes it impossible to fabricate the liquid core photonic crystal fiber.

The method of the present invention is highly efficient because no additional process is required for blocking the cladding region. According to the method of the present invention, constituent optical fibers can be connected to each other without any change in the size of the core, which maintains the inherent characteristics of the photonic crystal fiber.

Specifically, the method of the present invention includes: cleaving a hollow optical fiber and a photonic crystal fiber; splicing the cleaved sections of the hollow optical fiber and the photonic crystal fiber using a fusion splicer; filling a functional material in a central holecore of the photonic crystal fiber through the hollow optical fiber as a delivery tube; and cleaving the photonic crystal fiber including the core filled with the functional material.

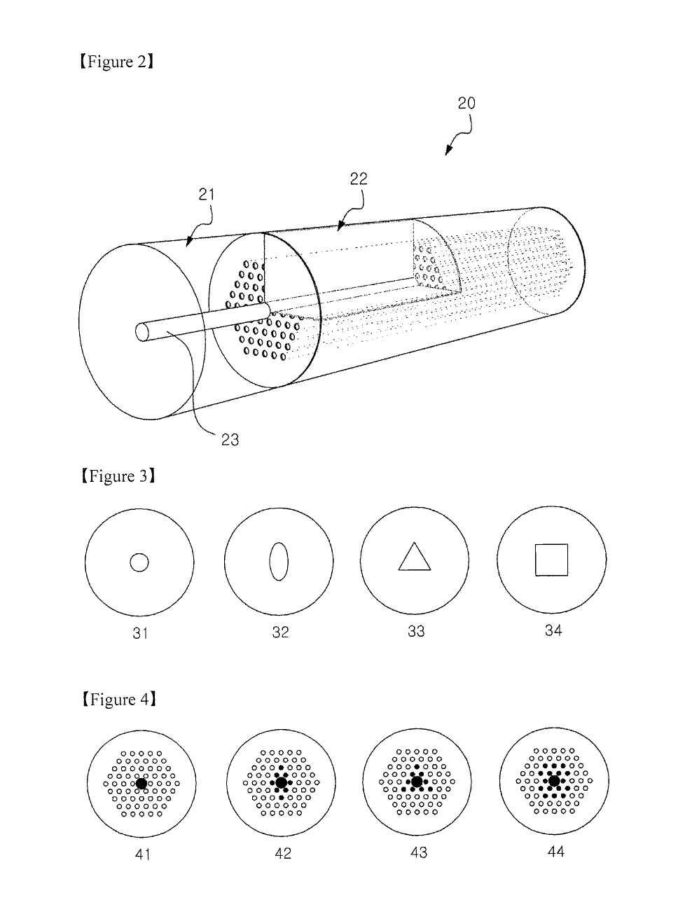

FIG. 2 illustrates a structure in which a hollow optical fiber 21 and a photonic crystal fiber 22 are spliced together in accordance with one embodiment of the present invention. The diameter of a central hole of the hollow optical fiber 21 is smaller than or identical to that of a central hole of the photonic crystal fiber 22. After fusion splicing of the two optical fibers, the liquid can be induced to fill only the central hole of the photonic crystal fiber through one end of the hollow optical fiber.

The hollow optical fiber and the photonic crystal fiber may be spliced together by aligning the cleaved sections of the hollow optical fiber and the photonic crystal fiber at a gap of 40 to 55 μm, followed by arc discharge heating at an intensity of 10 mA for 2 to 3 seconds. The arc discharge heating may be performed once or intermittently two or three times.

A pump may be provided at the opposite side to the side of the hollow optical fiber spliced to the photonic crystal fiber to fill the functional material in the central hole of the photonic crystal fiber through the hollow optical fiber as an delivery tube.

Examples of possible cross sections of hollow optical fibers having various hollow shapes that can be used in the present invention are illustrated in FIG. 3. A circular hollow optical fiber 31, an elliptical hollow optical fiber 32, a triangular hollow optical fiber 33, and a tetragonal hollow optical fiber 34 can be seen from the left-hand side of FIG. 3. In principle, a hollow optical fiber for light guide includes a central hole, a ring core doped with a high refractive index material outside the central hole, and a cladding outside the ring core. In contrast, in the method of the present invention, when the hollow optical fiber is used as a liquid delivery tube rather than as a light waveguide, there is no need to form a ring core in the hollow optical fiber, as illustrated in FIG. 3.

FIG. 4 illustrates preferable results obtainable when the hollow optical fibers illustrated in FIG. 3 are used as liquid delivery tubes. In FIG. 4, the shaded portions indicate portions filled with the liquid through the hollow optical fibers. According to the method of the present invention, the core shape of the photonic crystal fiber may vary depending on the central hole shape of the hollow optical fiber as a delivery tube for liquid filling.

The method of the present invention is advantageous in terms of ease of fabrication over conventional fabrication methods. Another advantage of the method according to the present invention is that the core can be adjusted to a desired shape regardless of the size of the air holes, as can be seen from FIG. 4.

### Mode for Invention

The present invention will be explained in more detail with reference to the following examples. However, these examples serve to provide further appreciation of the invention and it will be obvious to those with ordinary knowledge in the art that they are not intended to limit the scope of the invention.

### EXAMPLES

A hollow optical fiber and a photonic crystal fiber are used to fabricate a liquid core photonic crystal fiber according to one embodiment of the present invention.

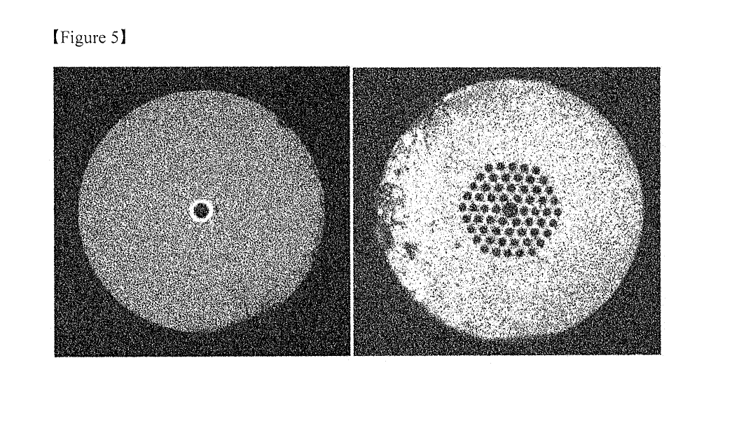

The hollow optical fiber may have a central hole having basic circular shape shown on the left side of FIG. 5. Alternatively, the hollow optical fiber may have other central hole shapes, including elliptical, tetragonal, and triangular shapes in cross section. The photonic crystal fiber may have a central solid or air defect. The use of the photonic crystal fiber having a central air defect is advantageous for the fabrication of the liquid core photonic crystal fiber. The photonic crystal fiber having a central air defect is used, as shown on the right side of FIG. 5. The structural specifications of the hollow optical fiber and the photonic crystal fiber used are shown in Table 1.

TABLE 1

| | | Central | Diameter | |
|---|---|---|---|---|
| | Outer | hole | of cladding | Lattice |
| | diameter | diameter | air holes | constant |
| | (μm) | (μm) | (μm) | (μm) |
| Hollow optical fiber | 125 | 7 | — | — |
| Photonic crystal fiber | 127.5 | 7.2 | 4.1 | 6.3 |

### Fabrication Example 1

(1) Splicing of the Hollow Optical Fiber and the Photonic Crystal Fiber

For the fabrication of the liquid core photonic crystal fiber, a functional liquid is filled in the central hole of the photonic crystal fiber through the hollow optical fiber. To this end, the air holes formed at both ends of the photonic crystal fiber should be maintained constant without size reduction during splicing between the photonic crystal fiber and the hollow optical fiber. When a splicing condition for general single-mode optical fibers (SMF-28) is used, air holes at both ends are completely blocked, and as a result, a liquid cannot be induced through the hollow optical fiber, making it impossible to fill the liquid.

Optimized intensities and times of arc discharge for splicing between the hollow optical fiber and the photonic crystal fiber using a fusion splicer (Ericsson FSU975) are compared with those of arc discharge for splicing single-mode optical fibers. The results are shown in Table 2. By reducing the intensities of arc discharge and the number of arc discharge steps, the influence of heat generated during splicing on the size reduction of air holes is minimized.

TABLE 2

| | | Fabrication |
|---|---|---|
| | Comparative | Example 1-(1) |
| | Example | (Splicing |
| | (Splicing | between |
| | between | hollow optical |
| | general | fiber and |
| | single-mode | photonic |
| | optical fibers) | crystal fiber) |
| Gap (μm) before discharge | 50 | 50 |
| Overlap (μm) after discharge | 10 | 3 |
| Time (s) of first arc discharge step | 0.3 | — |
| Intensity (mA) of first arc discharge step | 10.5 | — |
| Time (s) of second arc discharge step | 2.0 | 3.0 |
| Intensity (mA) of second arc discharge step | 16.3 | 10 |
| Time (s) of third arc discharge step | 2.0 | — |
| Intensity (mA) of third arc discharge step | 12.5 | — |

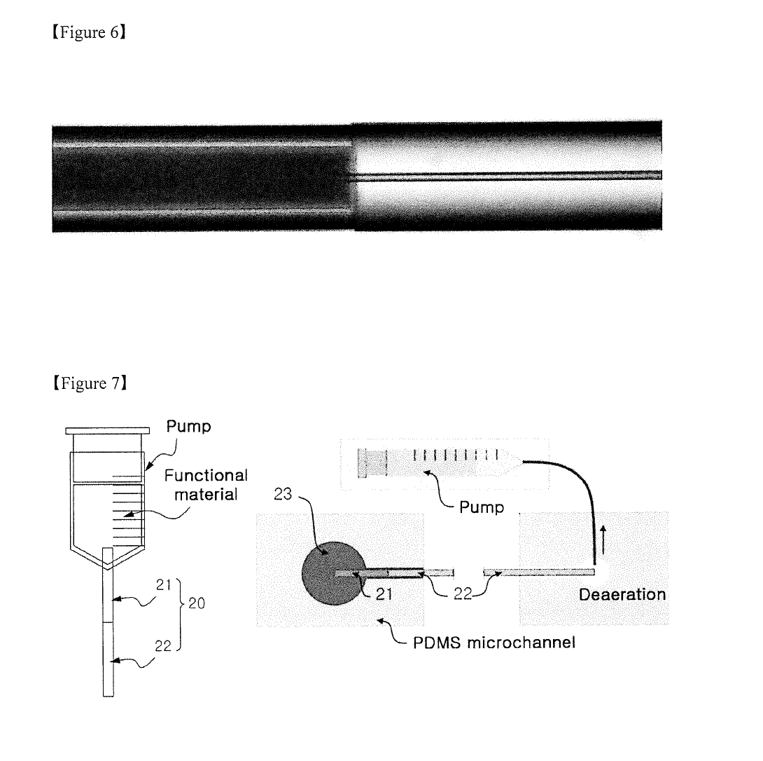

FIG. 6 shows a fused portion between the hollow optical fiber and the photonic crystal fiber under the optimized splicing conditions in accordance with a preferred embodiment of the present invention.

For long-term use, the fused portion between the two optical fibers after splicing can be reinforced with an optical fiber protection sleeve. A temperature of 90-130 ° C. is necessary for sleeve shrinkage. Since this temperature is much lower than the melting point of glass, it has no influence on the size reduction of air holes.

(2) Filling of the Liquid Core Photonic Crystal Fiber with Liquid

The end of the hollow optical fiber spliced to the photonic crystal fiber without size reduction of air holes in Fabrication Example 1-(1) is brought into contact with a liquid sample. Then, the liquid can be filled in the photonic crystal fiber through the hollow optical fiber as a liquid delivery tube.

A fluid pump, such as an air compressor, may be provided at the other end of the photonic crystal fiber to shorten the filling time. Without the pump, the liquid may be injected from a liquid reservoir through the capillary tubes of the hollow optical fiber and the photonic crystal fiber by capillary force.

At this time, it is necessary to minimize adverse effects caused by the force of gravity acting on the liquid during injection period. For this purpose, the pump or a syringe, the hollow optical fiber, and the photonic crystal fiber are arranged in this order from the top in the vertical direction, as illustrated in FIG. 7. With this arrange, the functional liquid filled in the pump is allowed to be injucted into the photonic crystal fiber through the hollow optical fiber.

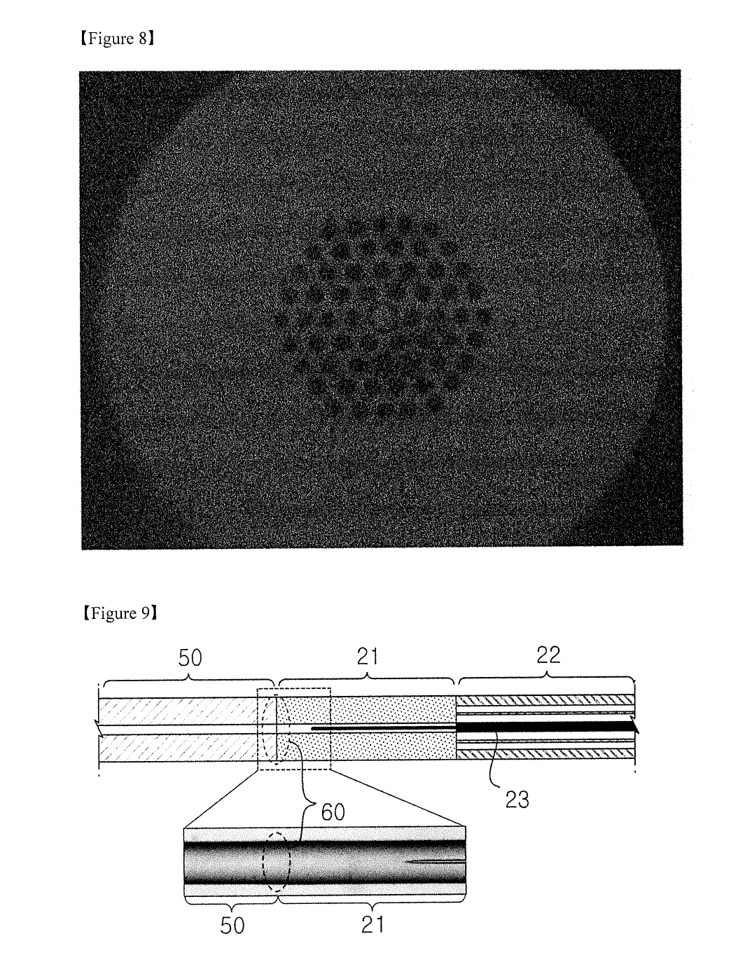

FIG. 8 is an image showing a cross section of the end of the photonic crystal fiber about 60 min after liquid filling. The image shows that the central core area is filled with the liquid. The liquid is deionized water and the sum of the lengths of the hollow optical fiber and the photonic crystal fiber is about 30 cm. The average diameter of the air holes filled with the liquid is 6.5 μm.

When the liquid is filled at a flow rate of 1 μL/min using the fluid pump, the same result can be obtained after about 1 min. When the liquid is highly viscous, the filling speed of the liquid can be increased by controlling the pumping speed of the fluid pump. The liquid may be, for example, a refractive index liquid whose viscosity is 100-1000 times higher than that of deionized water. In this case, the refractive index liquid can be pushed a distance of about 23 cm after 60 min and 45 cm after 120 min at a flow rate of 15 mL/min.

(3) Retention of Liquid in the Liquid Core Photonic Crystal Fiber

The liquid may be vaporized from both ends of the liquid core photonic crystal fiber fabricated through Fabrication Examples 1-(1) and 1-(2) due to its inherent characteristics. Since the amount of the liquid filled in the liquid core photonic crystal fiber is as small as a few pL to a few tens of nL, loss of only a few fL of the liquid by evaporation greatly affects the light guiding characteristics of the liquid core photonic crystal fiber. Continuous vaporization of the liquid causes a non-uniform state of liquid filling in the liquid core photonic crystal fiber. For example, when 0.3 pL of the liquid is vaporized from the liquid core photonic crystal fiber having a diameter of 6 μm, air layers of 10 μm or more are created and randomly distributed in the liquid waveguide.

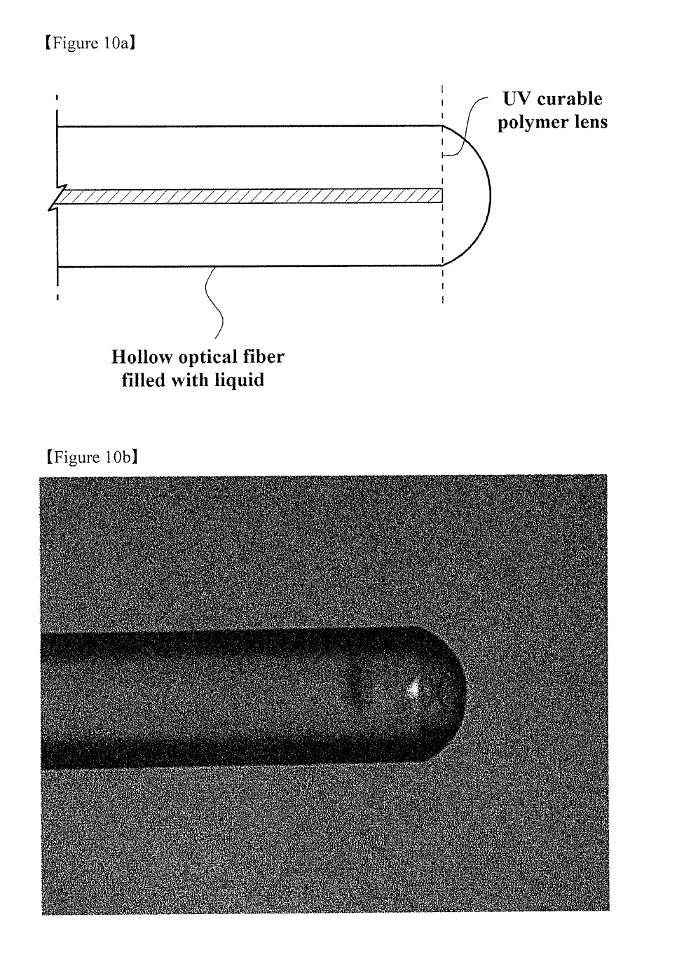

To avoid this problem, two proposals can be considered according to the desired application of the liquid core photonic crystal fiber. The liquid core photonic crystal fiber fabricated after liquid filling may be directly used as an active or passive device, such as a birefringence device, a fluorescent dye laser, or an ultra-broadband laser. In this case, a UV-curable polymer is brought into contact with both ends of the liquid core photonic crystal fiber to form semispherical lenses, which are then cured by UV irradiation to seal the liquid core photonic crystal fiber, completing the fabrication of a liquid core photonic crystal fiber device. This concept is illustrated in FIG. 10a. NOA61 (Norland Optical Adhesives) is used as the UV-curable polymer and the result is shown in FIG. 10b. Other examples of suitable UV-curable polymers are NOA68 and NOA81 (Norland Optical Adhesives).

In this case, for sealing with the UV lenses, the liquid core photonic crystal fiber device has a hollow optical fiber-photonic crystal fiber-hollow optical fiber structure. The sealed device can be easily connected to input/output terminals using a mechanical splicer. This case can be applied to both inflammable and noninflammable liquids. Particularly, when a noninflammable liquid is used, adiabatic splicing with input/output terminals using a fusion splicer is also possible.

On the other hand, particularly, when the liquid core photonic crystal fiber is applied to a chemical sensor or biosensor, it is necessary to vary the characteristics of the filled liquid with time. In this case, after optical light input/output terminals and the liquid core device are accommodated in a PDMS microfluidic system, light is guided and analysis can be performed during continuous supply of the liquid.

### Experimental Example 1

### Incidence of Light on the Liquid Core Photonic Crystal Fiber

Light is launched to the liquid core photonic crystal fiber fabricated in Fabrication Example 1. Effective incidence of light from conventional light sources (e.g., white light sources and laser diodes) is analyzed numerically and verified empirically. The hollow optical fiber as a liquid delivery tube is advantageous in terms of ease of mode conversion from a general single-mode optical fiber. Due to this advantage, the hollow optical fiber can be used as a light waveguide for effective incidence of light on the liquid core photonic crystal fiber. Accordingly, there is no need to remove the hollow optical fiber after completion of the liquid filling.

For this usage, an important requirement is that a ring core doped with a high refractive index material should be present in the hollow optical fiber. Otherwise, a large amount of light is lost to the cladding because the central air hole filled with liquid has a lower refractive index than the cladding.

Particularly, when the liquid is an aqueous solution having a refractive index of 1.3-1.4), which is lower than that of the cladding of the hollow optical fiber (n=1.457 at a wavelength of 635 nm), the absence of a ring core doped with a high refractive index material in the hollow optical fiber leads to loss of a large amount of light to the cladding because the central air hole filled with aqueous solution has a lower refractive index than the cladding.

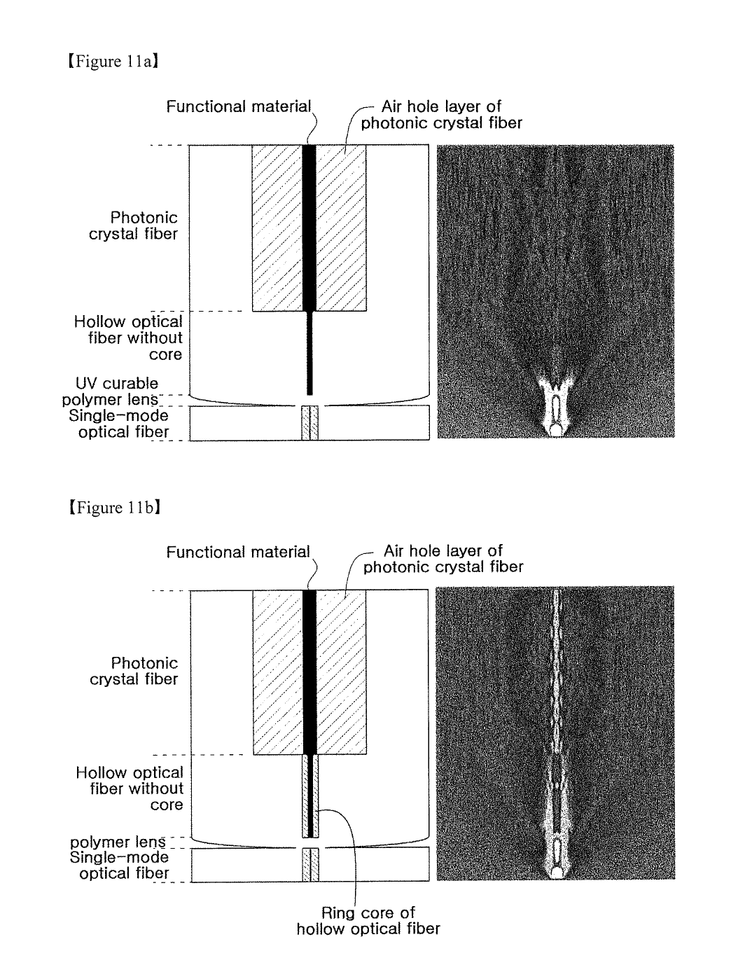

FIG. 11 shows analysis results of light guiding characteristics assuming that deionized water (n=1.33) is filled in the photonic crystal fiber having air holes whose air-fillingratio (d/L) is 0.9 and a fundamental mode having a Gaussian intensity distribution and a wavelength of 1.55 is incident thereon. FIGS. 11 and 11b illustrate the absence and presence of the ring core, respectively. When the ring core is present (FIG. 11b), optical loss can be effectively reduced by controlling the correlations among the air hole size of the hollow optical fiber, the thickness of the ring core, and the size of the central air hole of the photonic crystal fiber.

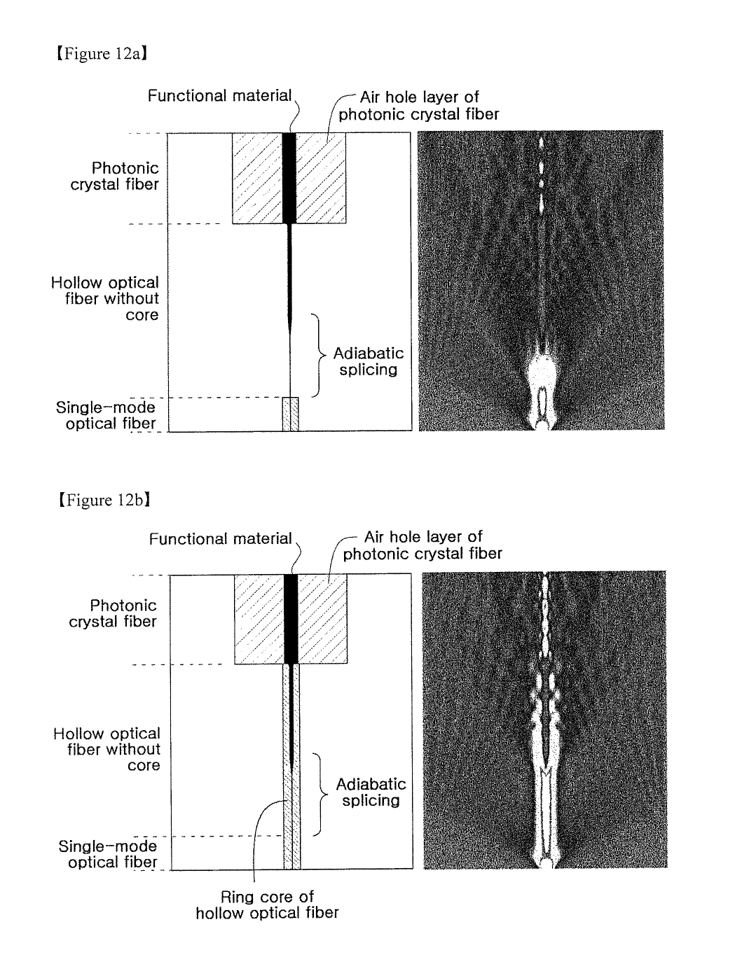

In the case of the liquid core photonic crystal fiber filled with the noninflammable liquid in Fabrication Example 1-(3), a single-mode optical fiber is adiabatically spliced to the hollow optical fiber, as illustrated in FIG. 9. In this case, a adiabatic mode conversion is possible from the fundamental Gaussian mode of the single-mode optical fiber to the fundamental ring mode of the hollow optical fiber. This mode conversion implies less optical loss. FIGS. 12a and 12b illustrate the absence and presence of a ring core, respectively. Even when a single-mode optical fiber is adiabatically spliced to the hollow optical fiber (FIG. 12b), effective light guiding is confirmed due to the presence of the ring core.

In accordance with the present invention, the hollow optical fiber (10 cm long) is spliced to the photonic crystal fiber (30 cm long), the liquid having a refractive index of 1.465 is filled therein, a UV-curable polymer lens is formed at one end of the liquid core photonic crystal fiber to seal the filled liquid, a single-mode optical jumper cord is connected to the hollow optical fiber using a mechanical splicer, and 635 nm laser light is launched to the liquid core photonic crystal fiber. As a result, effective incidence of light with less loss is confirmed.

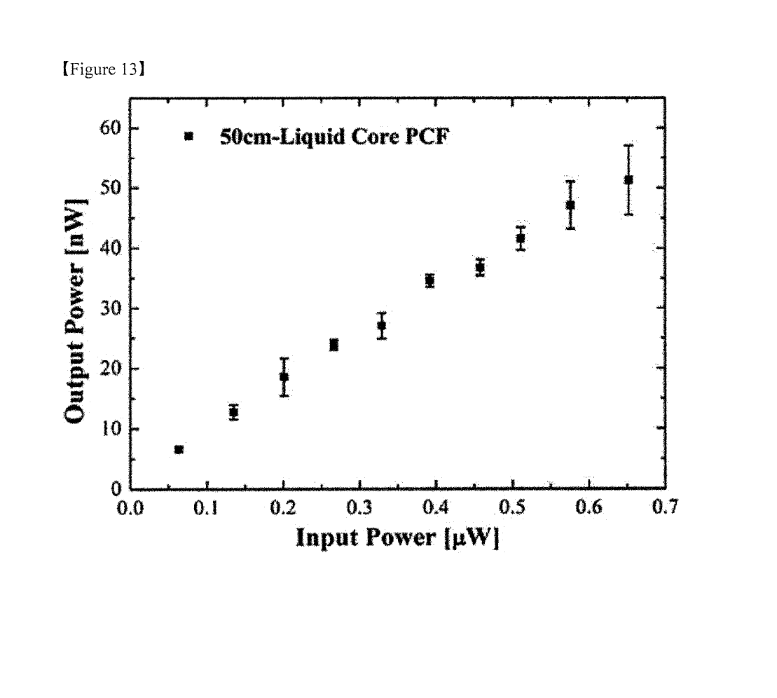

In accordance with Fabrication Example 1-(3), the same refractive index liquid is filled in the spliced hollow optical fiber-photonic crystal fiber-hollow optical fiber structure, and UV-curable polymer lenses are formed at both ends of the spliced structure to prevent loss of the liquid by evaporation. Thereafter, single-mode optical jumper cords are connected to both ends of the resulting structure using a mechanical splicer, 635 nm laser light is guided, and the output power of light is measured. As can be seen from FIG. 13, the output power increases linearly with increasing power of the incident light (an average optical loss of 0.21 dB/cm is observed).

### INDUSTRIAL APPLICABILITY

Despite increasing power of the incident laser, the distribution of the filled liquid is maintained constant without damage, indicating no impairment of guiding characteristics. That is, complete filling of the waveguide with the liquid without cavities can be indirectly confirmed.

1. A hybrid photonic crystal fiber comprising:
(i) a central hole extending in the longitudinal direction at the central portion of the photonic crystal fiber and having a diameter of 4 to 15 μm;
(ii) an inner cladding also formed in the longitudinal direction outside the central hole, having a hexagonal arrangement of air holes, each of which has a diameter of 2 to 5 μm and a lattice constant of 4.5 to 7 μm;
(iii) an annular outer cladding surrounding the outer surface of the inner clad; and
(iv) a core formed by filling a functional material in the central hole.

2. The hybrid photonic crystal fiber according to claim 1, wherein the photonic crystal fiber has an outer diameter of 100 to 250 μm.

3. The hybrid photonic crystal fiber according to claim 1, wherein the core has a circular, elliptical, triangular, tetragonal, pentagonal or hexagonal shape in cross section.

4. The hybrid photonic crystal fiber according to claim 1, wherein the functional material is at least one liquid selected from deionized water, fluorescent dyes and high nonlinear liquids, at least one liquid crystal selected from nematic fluids, or at least one biofluid selected from blood, urine, lymph and saliva.

5. A method for fabricating a hybrid photonic crystal fiber, comprising:
(A) cleaving a hollow optical fiber and a photonic crystal fiber;
(B) splicing the cleaved sections of the hollow optical fiber and the photonic crystal fiber using a fusion splicer;
(C) filling a functional material in a core of the photonic crystal fiber through the hollow optical fiber as a delivery tube; and
(D) cleaving the photonic crystal fiber comprising the core filled with the functional material.

6. The method according to claim 5, wherein the hollow of the hollow optical fiber has a circular, elliptical, triangular, tetragonal, pentagonal or hexagonal shape in cross section.

7. The method according to claim 5, wherein the functional material is at least one liquid selected from deionized water, fluorescent dyes and high nonlinear liquids, at least one liquid crystal selected from nematic fluids, or at least one biofluid selected from blood, urine, lymph and saliva.

8. The method according to claim 5, wherein the hollow optical fiber has an outer diameter of 100 to 250 μm and a central hole diameter of 4 to 15 μm.

9. The method according to claim 5, wherein the photonic crystal fiber has an outer diameter of 100 to 250 μm and a central hole diameter of 4 to 15 μm, and has cladding air holes, each of which has a diameter of 2 to 5 μm and a lattice constant 4.5 to 7 μm.

10. The method according to claim 5, wherein, in step (B), the hollow optical fiber and the photonic crystal fiber are spliced together by aligning the cleaved sections of the hollow optical fiber and the photonic crystal fiber at a gap of 40 to 55 μm, followed by arc discharge heating at an intensity of 10 mA for 2 to 3 seconds.

11. The method according to claim 10, wherein the arc discharge heating is performed once or intermittently two or three times.

12. The method according to claim 5, wherein, in step (C), the functional material is filled in the core of the photonic crystal fiber through the hollow optical fiber as a delivery tube by a fluid pump provided at the opposite side to the side of the hollow optical fiber spliced to the photonic crystal fiber.
